(19) United States
(12) Patent Application Publication
(10) Pub. No.: US 2005/0252563 A1
(43) Pub. Date: Nov. 17, 2005

(54) Gate valve

(75) Inventors: Sylvester Ledo, Swansea, MA (US); David Mooney, Lincoln, RI (US)

Correspondence Address: SALTER & MICHAELSON;THE HERITAGE BUILDING, 321 SOUTH MAIN STREET, PROVIDENCE, RI, 029037128, US

(73) Assignee: Primary Flow Signal, Inc.

(21) Appl. No.: 11/119,841

(22) Filed: May 2, 2005

Related U.S. Application Data
(60) Provisional application No. 60/569,908, filed on May 11, 2004.

(51) Int. Cl. F16K 27/00

(52) U.S. Cl. 137/884

(57) ABSTRACT

A valve manifold that is adapted to be positioned between a main flow line and a measuring instrument, including a body; a pair of fluid flow passages in said body, each having one port for coupling with the main flow line and an opposite end port for coupling with the measuring instrument; a pair of valve members for controlling the fluid flow through the respective pair of fluid flow passages; and a pair of handles for respectively controlling said pair of valve members. Each of the valve members includes a control end coupling with a respective handle to control the position of the valve member and a valving end adapted for positioning in a valve passage that extends transverse to the fluid flow passage. Each valve member further has a resilient seal member that is supported by either the body or valve member and that, in a closed position, provides a seal about the fluid flow passage between the valve member and body so as to inhibit fluid flow through the fluid flow passage, and that, in at least a partially open position, enables fluid flow through the fluid flow passage.

### CROSS REFERENCE TO RELATED APPLICATIONS

This application claims priority under 35 U.S.C. § 119(e) to co-pending U.S. Provisional Patent Application Ser. No. 60/569,908, entitled GATE VALVES MANIFOLD, filed May 11, 2004.

### TECHNICAL FIELD

The present invention pertains to a new and improved gate valve construction. The gate valve may be used in a valve manifold arrangement used for differential pressure measurement, but may also be used in other valve applications.

### BACKGROUND

The application of so-called instrument manifolds is well established in the process flow industry, finding significant utilization as a means of blocking flow between differential pressure flow primaries and their secondary instrumentation for purposes of maintenance, repair and/or transmitter (secondary) calibration, and zero setting for either gas or liquid process fluids.

This practice has prevailed for many decades, consisting initially of nothing more than an impulse piping scheme including valves and fittings designed to serve the function. Manufacturers eventually designed, developed and proliferated dedicated equipment, namely, “instrument manifolds”, that incorporate valving (usually either two, three or five valves) in an integral, compact metal body also containing internal machined passageways that allow direction and control of flow by manipulation of the valves, which for the most part were traditional cone seat valves. Typical valve manifolds are shown in U.S. Pat. Nos. 3,596,680 and 4,602,657. These manifolds are also capable of directly mounting the secondary (DP transmitter) integrally onto an integral flange, thereby further simplifying field installation and piping requirements, which is another significant benefit of using manifolds of this type. Generally, the valves incorporated in the existing manifolds can be either soft or hard seat, depending upon the application requirements.

A constant source of concern is the failure of existing manifolds to produce 100% leak-proof seals. This problem is troubling, because it leads to adverse consequences that may include the inability to properly zero and/or calibrate transmitters, unintentional leakage of line fluid to atmosphere during replacement or maintenance of secondary instrumentation and inability to establish correct and/or accurate differential pressure, to name but a few.

Accordingly, it is an object of the present invention to provide an improved valve arrangement that is leak-proof.

Another object of the present invention is to provide an improved gate type valve that can be used in a wide variety of applications and that is relatively simple in construction.

Still another object of the present invention is to provide a gate valve that has excellent wear characteristics as well as being self-cleaning in use.

### SUMMARY OF THE INVENTION

To accomplish the foregoing and other objects, feature and advantages of the present invention there is provided a valve manifold that is adapted to be positioned between a main flow line and a measuring instrument, comprising a body; a pair of fluid flow passages in the body, each having one port for coupling with the main flow line and an opposite end port for coupling with the measuring instrument; a pair of valve members for controlling the fluid flow through the respective pair of fluid flow passages; a pair of handles for respectively controlling the pair of valve members; each valve member including a control end coupling with a respective handle to control the position of the valve member and a valving end adapted for positioning in a valve passage that extends transverse to the fluid flow passage; and each valve member further having a resilient seal member that is supported by at least either the body or the valve member and that, in a closed position of the valve member, provides a seal about the fluid flow passage between the valve member and body so as to inhibit fluid flow through the fluid flow passage, and that, in at least a partially open position of the valve member, enables fluid flow through the fluid flow passage.

In accordance with other aspects of the present invention the valve manifold may include a valve support member disposed between the handle and valve member and rotatable by the handle to linearly move the valve member between open and closed positions thereof; a first nut for rotatably supporting the valve support member and a second nut threaded between the first nut and the body and having the valve member supported therein; the valve support member has an internal threaded bore that receives a threaded control end of the valve member whereby, upon rotation of the valve support member, the valve member transitions linearly toward and away from the corresponding fluid flow passage; the valving end of the valve member comprises a non-circular paddle that maintains the valve member non-rotational; the sealing member comprises an annular seal having a diameter that is greater than the diameter of the fluid flow passage; a pair of annular seals on opposite sides of the valve member valving end; the valve member valving end is in the form of a paddle having opposed flat surfaces and said resilient seal member comprises a pair of O-rings supported at said respective flat surfaces; the valve member valving end is in the form of a paddle that extends across the fluid flow passage in opposed channels; and the free end of the paddle extends into a closed channel.

In accordance with another aspect of the present invention there is provided a gate valve comprising: a body; at least one flow passage in the body through which a fluid is adapted to flow; at least one valve member for controlling the fluid flow through the at least one passage and having closed and at least partially open positions; the valve member having one end that is adapted to control the position of the valve member for transition transverse to said flow passage between open and closed positions; the valve member having another end forming a valve gate that is adapted to extend through a valve passage that is transverse to and extends to opposite sides of the flow passage; and a resilient seal member disposed between the valve gate and body and that, in the closed position of the valve member, provides a seal entirely about the flow passage between the valve gate and body so as to block flow through the flow passage, and that, in the at least partially open position of the valve member, enables fluid flow through the flow passage.

In accordance with other aspects of the present invention the gate valve may include a valve support member disposed between a control handle and the valve member and rotatable by the handle to linearly move the valve member between open and closed positions thereof; the resilient seal member comprises an annular seal having a diameter that is greater than the diameter of the fluid flow passage; the valve gate is in the form of a paddle having opposed flat surfaces and the resilient seal member comprises a pair of O-rings supported at said respective flat surfaces; and the valve gate is in the form of a paddle that extends across the fluid flow passage in opposed channels.

In accordance with still other aspects of the present invention the flow control valve comprises: a valve body; a flow passage in the valve body through which a fluid is adapted to flow; a valve means for controlling the fluid flow through the flow passage and having a closed position and an at least partially open position; a control means for controlling the valve means; a valve passage that is disposed substantially transverse to the flow passage and that accommodates a paddle means of the valve means; and a resilient seal means disposed between the paddle means and valve body and that, in the closed position of the valve means, provides a seal entirely about the flow passage between the paddle means and body so as to block flow through the flow passage, and that, in the at least partially open position of the valve means, enables fluid flow through the flow passage.

In accordance with another aspect of the present invention the flow control valve includes a valve support means disposed between a control handle and the valve means and rotatable by the handle to linearly move the valve means between open and closed positions thereof; the resilient seal means comprises an annular seal having a diameter that is greater than the diameter of the fluid flow passage; and the paddle means has opposed flat surfaces and the resilient seal means comprises a pair of O-rings supported at said respective flat surfaces.

### BRIEF DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1 is a perspective view of a first embodiment of a valve manifold in accordance with the present invention;

FIG. 2 is an exploded perspective view of the valve and control members of the valve manifold of FIG. 1;

FIG. 3 is a partial perspective view of FIG. 1 with the valve and control members exploded away;

FIG. 4 is a cross-sectional partial perspective view of the valve manifold of FIG. 1 as taken along line 4-4 of FIG. 1;

FIG. 5 is a cross-sectional view of the valve manifold of FIG. 1 in a closed position thereof;

FIG. 6 is a cross-sectional view of the valve manifold of FIG. 1 in an open position thereof;

FIG. 7 is a partial perspective view of a second embodiment with the valve and control members exploded away;

FIG. 8 is a cross-sectional partial perspective view of the valve manifold of the second embodiment;

FIG. 9 is a cross-sectional view of the valve manifold of the second embodiment in a closed position thereof; and

FIG. 10 is a cross-sectional view of the valve manifold of the second embodiment in an open position thereof.

### DETAILED DESCRIPTION

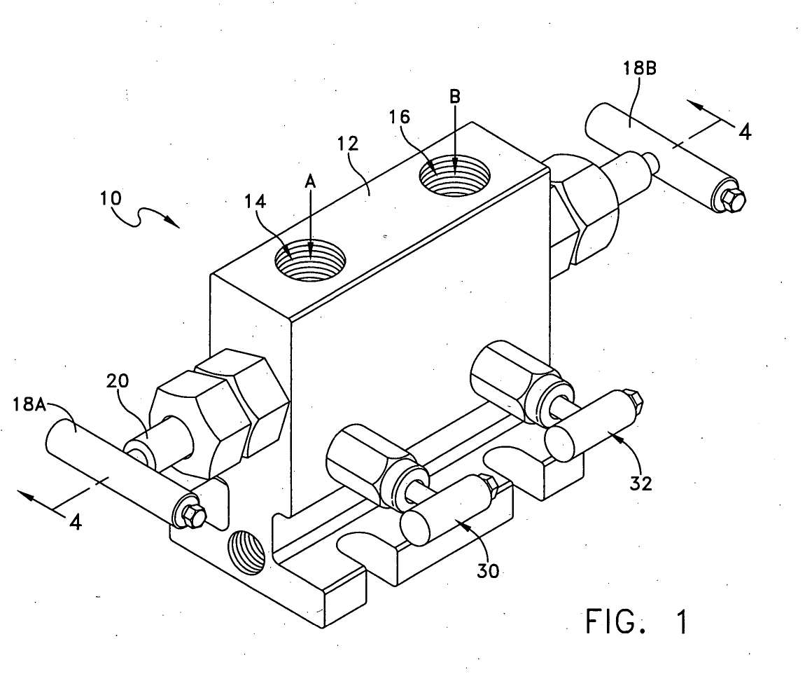

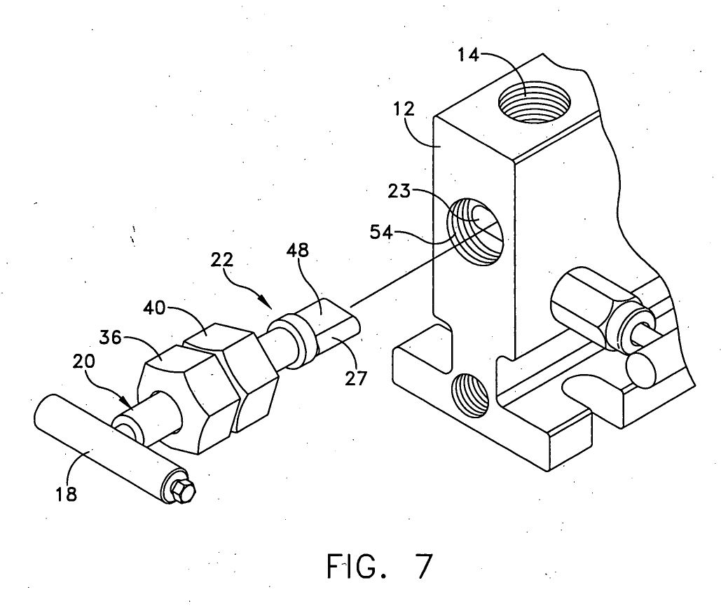

There are two embodiments that are described in the drawings, one in which the sealing member is supported by the valve paddle itself and a second embodiment in which the sealing member is supported by or in the valve body. The first embodiment is illustrated in FIGS. 1-6 and the second embodiment is illustrated in FIGS. 7-10. In the first embodiment the manifold assembly is shown generally at 10 and comprises a precisely machined body 12 having a pair of flow passages 14, 16 through which a gaseous or liquid medium is free to flow when the gate valves are in their open position.

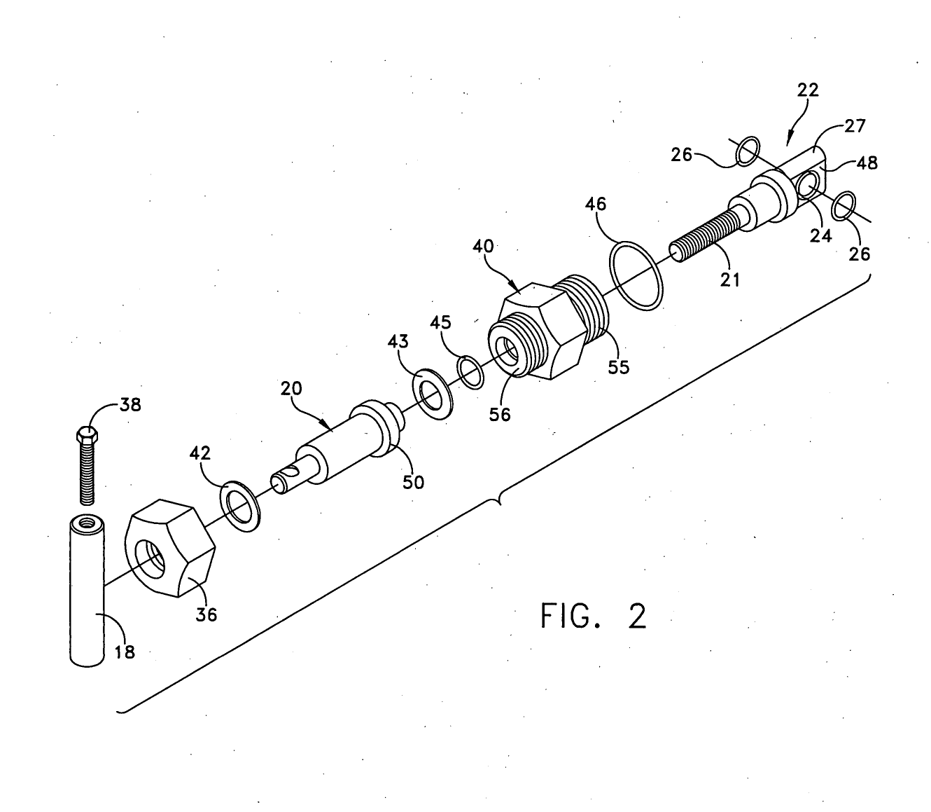

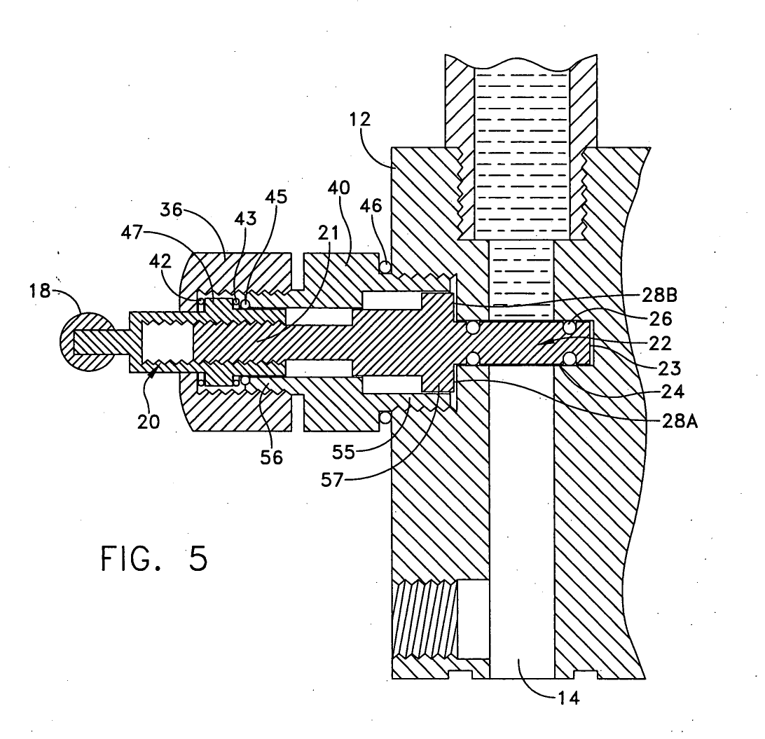

The component parts of the master valve stem are shown in FIG. 2 in disassembled relation. Basically, the valve stem comprises a handle 18 which, when rotated, imparts rotation to support member 20 which is threadedly attached to stem 21 of valve plate or paddle 22. Since, however, paddle 22 is snugly and slidably received within a precisely machined pocket or slot 23 in the manifold body, it is unable to rotate but rather will move in a linear direction. Paddle 22 has O-ring grooves 24 on each side thereof which receive O-rings 26 of suitable sealing material. Thus, rotation of handle 18 will cause linear movement of paddle 22 until it reaches the end of its travel, which is defined by cooperating shoulders shown at 28 in FIG. 5. In this position, the paddle extends across the direction of flow, illustrated by arrows A and B in FIG. 1, to block same, and specifically, the O-rings 24 on each side of the paddle are automatically in proper alignment with the flow orifices or passages 14 or 16 so as to effectively block all flow therethrough, without any occurrence of leakage. Refer to FIG. 5.

It will be understood that the assembly shown in FIG. 1 has two such valve assemblies, one for blocking flow through passageway 14, and one for blocking flow through passageway 16. It should be noted, however, that this type of valve arrangement could also be readily utilized in other valving applications where conventional ball valves, gate valves, knife valves, and even butterfly valves might otherwise be used. The valve means of the present invention is useable for gas applications, but is not limited thereto, and will also provide excellent performance characteristics in water, steam or other fluid applications.

Referring further to the first embodiment illustrated in FIGS. 1-6, that particular manifold arrangement employs a pair of flow passages 14 and 16 in the manifold body 12. There are thus also two corresponding valves on either side of the valve body. These are controlled from the respective handles 18A and 18B. FIG. 1 also illustrates additional adjustment members 30 and 32 that may be associated respectively with flow passages 14 and 16. FIG. 1 also illustrates the interengageable nuts on either side of the manifold body for securing the respective valve assemblies. The components illustrated in FIG. 1 are shown in more detail, including the internal construction, in additional FIGS. 2-6.

As indicated previously, the complete valve stem or valve assembly is shown in FIG. 2 in an exploded perspective view. In addition to the handle 18, support member 20, and valve member 22, there is also provided a pair of interengageable nuts including a first internally threaded nut 36 and a dual threaded coupler 40. FIG. 2 also illustrates the securing screw 38 for attaching the handle 18 to the support member 20. Bushings 42 and 43 are illustrated in FIG. 2 disposed on either side of the flange 50. Seals or gaskets 45 and 46 are disposed on either side of the coupler 40. The valve member 22 includes, in addition to the threaded stem 21, a paddle end indicated in FIG. 2 at 27 and having oppositely disposed flat surfaces 48. Each of these surfaces has annular grooves 24 for receiving respective O-rings 26.

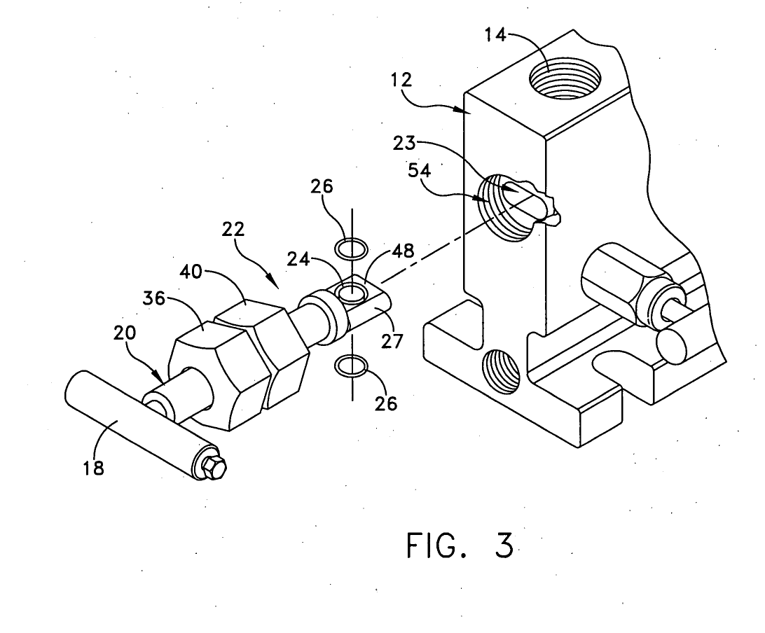

FIG. 3 is a perspective view showing a portion of the manifold body 12 and with the valve stem or valve assembly essentially exploded away from the threaded bore 54. The bore 54 leads to the precisely machined pocket or slot 23 that is dimensioned to receive the paddle end 27 of the valve member.

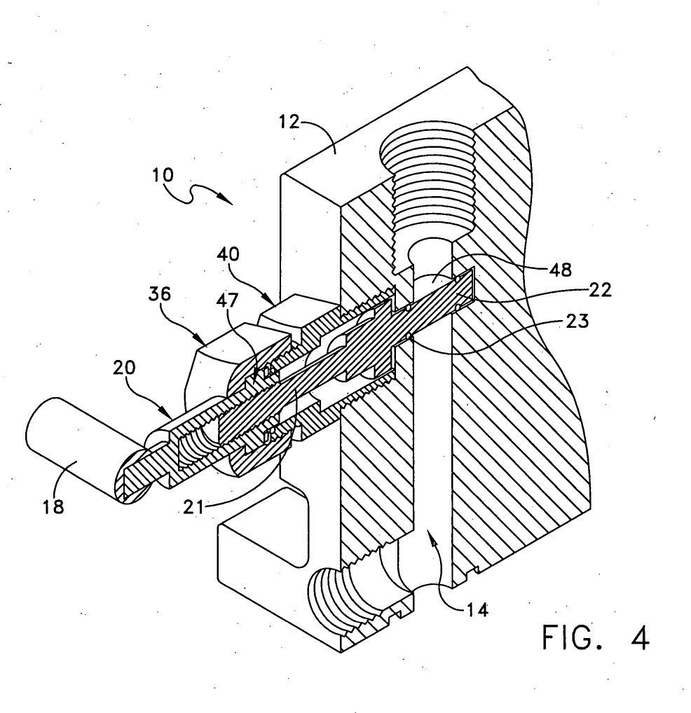

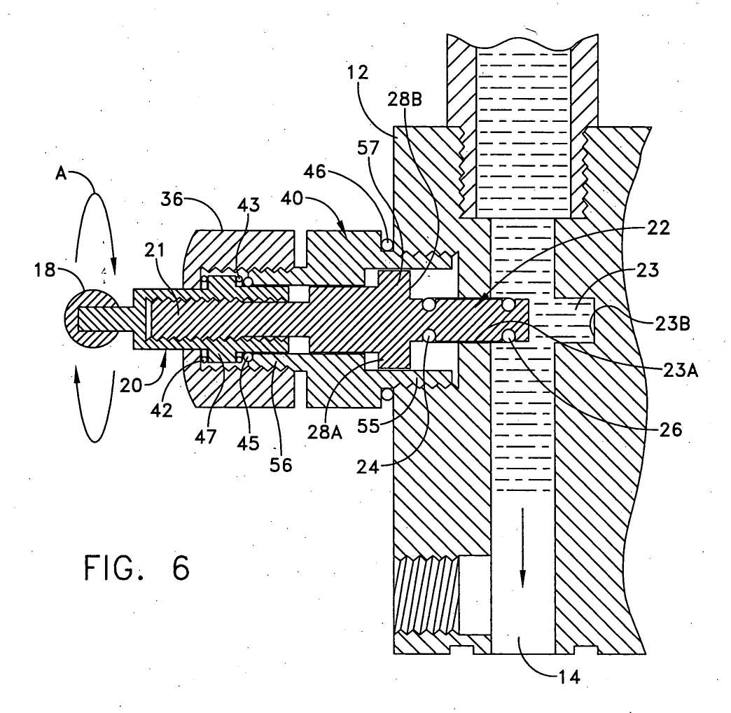

FIGS. 4-6 are cross-sectional views illustrating the valve assembly in place in the valve body 12. FIGS. 4 and 5 illustrate the valve in a closed position and FIG. 6 illustrates the valve in a position in which it is at least partially open. The valve member 22 is disposed as illustrated in FIGS. 4-6, with its paddle end 22 disposed within the similarly dimensioned pocket or slot 23. Actually, on one side of the flow passage 14, the slot is formed by a channel and on the opposite side by a closed pocket. These are aligned with each other, as illustrated in FIG. 6 so that as the paddle transitions linearly it is supported primarily in the channel section 23A and can extend into the oppositely disposed pocket 23B, as in the position of FIG. 5. The valve member 22 is secured in place primarily by means of the coupler 40 that has one side 55 threadedly engaged with the bore 54 and another side 56 that is threadedly engageable with the nut 36. The valve member 22 has a flange 57 defining shoulders 28A and 28B. These shoulders define the opposite extent positions of the valve member by virtue of contact of shoulder 28B with the valve body 12 in the closed position as illustrated in FIG. 5, and with the shoulder 28A engaged with the coupler 40 in the fully open position of the valve member. The coupler 40 is threadedly secured to the valve body having a gasket or sealing ring 46 disposed therebetween.

As indicated previously, the nut 36 threadedly engages with the end 56 of the coupler 40 as illustrated in FIGS. 5 and 6. This arrangement retains the support member 20 in a fixed linear position but enabling rotation thereof. For this purpose there are provided bushings 42 and 43 on opposite sides of the ridge 47 of the support member 20. Also, a gasket or sealing member 45 is provided between the coupler 40 and support member 20. The handle 18 is secured to the proximal end of the support member 20 by means of the securing bolt or screw 38.

The rotation of the handle 18, such as in the direction of the arrow A in FIG. 6 causes a corresponding rotation of the support member 20 about its longitudinal axis. The support member 20 is free to rotate via the bushings 42 and 43. With the stem 21 of the valve member 22 threadedly engaged with the threaded pocket in the support member 20, and with the valve member 22 itself not capable of rotation, then any rotation of the support member 20 imparts linear translation to the valve member 22. The valve member 22 is prevented from rotation by virtue of the flat surfaced paddle 27 engaging in the flat surfaced pocket or slot 23. Rotation of the handle 18 in a first direction imparts linear translation of the valve member in a first direction. Rotation of the handle 18 in the opposite direction imparts linear translation of the valve member in its opposite direction. FIG. 6 illustrates the valve assembly in a position in which the valve member is partially open with the shoulder 28A close to being bottomed out in the coupler 40. FIG. 5 on the other hand illustrates the handle 18 turned to a position wherein the shoulder 28B is urged against the valve body and the paddle end 27 of the valve member extends across the flow passage 14 in both the channel 23A as well as the pocket 23B. In that position, the center of the annular O-ring is preferably in line with the center of the flow passage 14.

Reference is now made to the second embodiment that is described herein in FIGS. 7-10. This embodiment is quite similar to the first embodiment and thus the same reference characters are used to describe like elements in the drawings. FIG. 7 is a perspective view showing a portion of the manifold body 12 and with the valve stem or valve assembly essentially exploded away from the threaded bore 54. The bore 54 leads to the precisely machined pocket or slot 23 that is dimensioned to receive the paddle end 27 of the valve member. In this embodiment, rather than having the sealing members or O-rings supported on the valve assembly they are supported in the body itself. Thus, as indicated in FIG. 7 the valve paddle surfaces 48 are flat without any grooves for the O-rings.

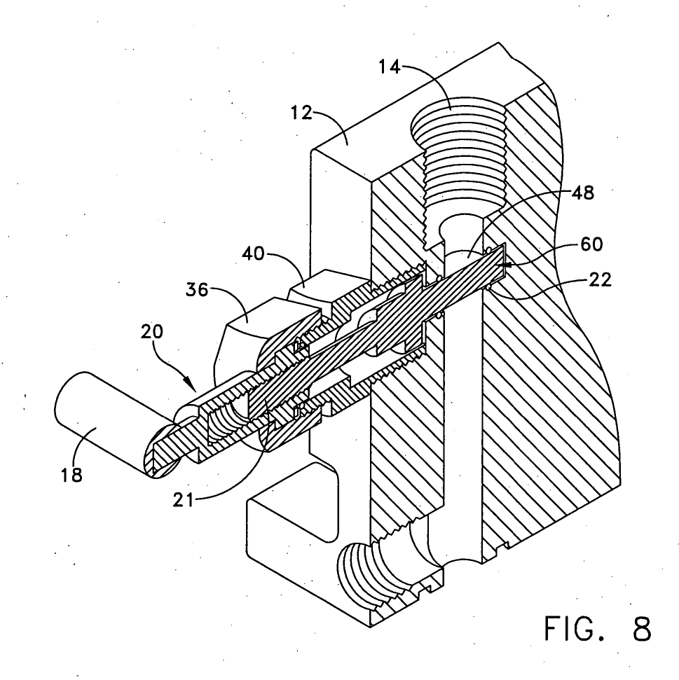

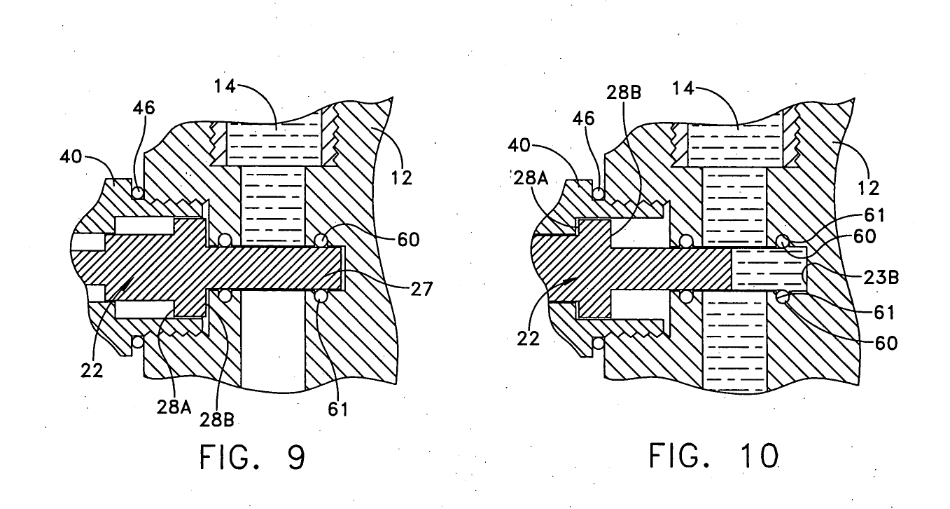

FIGS. 8-10 are cross-sectional views of the second embodiment illustrating the valve assembly in place in the valve body 12. FIGS. 8 and 9 illustrate the valve in a closed position and FIG. 10 illustrates the valve in a position in which it is at least partially open. The valve member 22 is disposed as illustrated in FIGS. 8-10, with its paddle end 22 disposed within the similarly dimensioned pocket or slot 23. Actually, on one side of the flow passage 14, the slot is formed by a channel and on the opposite side by a closed pocket. These are aligned with each other, as illustrated in, for example, FIG. 10 so that as the paddle transitions linearly it is supported primarily in the channel section 23A and can extend into the oppositely disposed pocket 23B, as in the position of FIG. 9. The valve member 22 is secured in place primarily by means of the coupler 40 that has one side 55 threadedly engaged with the bore 54 and another side 56 that is threadedly engageable with the nut 36. The valve member 22 has a flange 57 defining shoulders 28A and 28B. These shoulders define the opposite extent positions of the valve member by virtue of contact of shoulder 28B with the valve body 12 in the closed position as illustrated in FIG. 5, and with the shoulder 28A engaged with the coupler 40 in the fully open position of the valve member. The coupler 40 is threadedly secured to the valve body having a gasket or sealing ring 46 disposed therebetween.

As indicated previously, the nut 36 threadedly engages with the end 56 of the coupler 40 as illustrated in FIG. 8. This arrangement retains the support member 20 in a fixed linear position but enabling rotation thereof. For this purpose there are provided bushings 42 and 43 on opposite sides of the ridge 47 of the support member 20. Also, a gasket or sealing member 45 is provided between the coupler 40 and support member 20. The handle 18 is secured to the proximal end of the support member 20 by means of the securing bolt or screw 38.

The rotation of the handle 18 causes a corresponding rotation of the support member 20 about its longitudinal axis. The support member 20 is free to rotate via the bushings 42 and 43. With the stem 21 of the valve member 22 threadedly engaged with the threaded pocket in the support member 20, and with the valve member 22 itself not capable of rotation, then any rotation of the support member 20 imparts linear translation to the valve member 22. The valve member 22 is prevented from rotation by virtue of the flat surfaced paddle 27 engaging in the flat surfaced pocket or slot 23. Rotation of the handle 18 in a first direction imparts linear translation of the valve member in a first direction. Rotation of the handle 18 in the opposite direction imparts linear translation of the valve member in its opposite direction. FIG. 10 illustrates the valve assembly in a position in which the valve member is partially open with the shoulder 28A close to being bottomed out in the coupler 40. FIG. 9 on the other hand illustrates the handle 18 turned to a position wherein the shoulder 28B is urged against the valve body and the paddle end 27 of the valve member extends across the flow passage 14 in both the channel 23A as well as the pocket 23B. In that position, the center of the annular O-ring is preferably in line with the center of the flow passage 14.

Now, in FIGS. 8-10 it is noted that the flat surfaces of the valve paddle are without grooves while the O-rings 60 sit within corresponding grooves 61 in the valve body adjacent to the channel for the valve and the flow passage.

Although the drawings show a manually operated rotatable handle to provide linear movement of the valve paddle, such movement could also be achieved by other actuating means, such as pneumatic or hydraulic cylinder means, digitally controlled linear actuator means, and the like. Such other control techniques would allow remote actuation of the valve.

Other advantageous features of this invention are the fact that the O-rings provide a self-cleaning function during the course of normal valve operation and usage, due to the rubbing (or honing) of the interior contiguous surfaces of the machined valve slot. The fact that two O-rings are in place, one on each flat surface of the valve stem paddle, provides a natural back-up seal. If one of the two O-rings sustains damage through wear or other means, the second O-ring provides complete sealing capabilities between the upstream and downstream orifices of the process line. Process line detritus, i.e., fragments or contamination, which often collects on the wetted surfaces of the internals of any manifold or valve are naturally wiped off the sealing interior surfaces by motion of the valve stem paddle and O-ring arrangement in accordance with the present invention.

Although the valve stem paddle is linearly movable until its O-rings are in proper alignment with the flow passageways and the paddle can move no further, i.e., when the paddle has reached the end of its permissible travel, its O-rings are automatically in proper alignment with the flow passageways. Also, the slot through which the paddle moves has an extension which provides a pocket or chamber (23B) to receive any detritus that has been wiped clean as the paddle moves through the slot to the extent of its travel.

In the normal operation of the valve, the O-rings preferably do not fully withdraw from the machined valve pocket or slot, although the paddle preferably does withdraw sufficiently so that the flow passages are completely open, which allows for easy “rod-ability”, i.e., cleaning, of the flow passages.

As indicated before, there is described herein two embodiments that support the sealing member either in the valve body or on the valve stem. These embodiments have been described as using a pair of sealing members. However, the invention can also be readily practiced using only one sealing member. In the first embodiment that would include only one O-ring 26 on just one of the flat surfaces 48 of the valve paddle. The sealing member can be on either side of the valve paddle and effectively provides a seal to flow in the main passage. In the second embodiment only one O-ring 60 may be used. Again, that can be disposed on either side of the paddle in the body structure.

There has been described herein one arrangement for linearly moving the valve paddle, however, it is understood that various other arrangement can be employed. Both left and right hand threading may be employed. Other mechanisms may be used to move the valve paddle linearly such a rack and pinion arrangement or other known mechanisms.

Another advantage of the valve of this invention is that the operation of the valve is not contingent upon the material composition of the O-rings, although, depending on the flow material, softer or harder seals may be used as required. One of the advantages of the valve structure of the present invention is the use of O-rings as the sealing surface on a reciprocating valve paddle, substantially as described herein and including all equivalents thereof.

While this disclosure has been particularly shown and described with references to preferred embodiments thereof, it will be understood by those skilled in the art that various changes in form and details may be made therein without departing from the spirit and scope of the disclosure as defined by the appended claims.

1. A valve manifold that is adapted to be positioned between a main flow line and a measuring instrument, comprising:
a body;
a pair of fluid flow passages in said body, each having one port for coupling with the main flow line and an opposite end port for coupling with the measuring instrument;
a pair of valve members for controlling the fluid flow through the respective pair of fluid flow passages;
a pair of handles for respectively controlling said pair of valve members;
each said valve member including a control end coupling with a respective handle to control the position of said valve member and a valving end adapted for positioning in a valve passage that extends transverse to said fluid flow passage;
each said valve member further having a resilient seal member that is supported by at least one of said body and valve member and that, in a closed position of said valve member, provides a seal about said fluid flow passage between said valve member and body so as to inhibit fluid flow through said fluid flow passage, and that, in at least a partially open position of said valve member, enables fluid flow through said fluid flow passage.

2. The valve manifold of claim 1 including a valve support member disposed between said handle and valve member and rotatable by said handle to linearly move said valve member between open and closed positions thereof.

3. The valve manifold of claim 2 including a first nut for rotatably supporting said valve support member and a second nut threaded between said first nut and said body and having said valve member supported therein.

4. The valve manifold of claim 3 wherein said valve support member has an internal threaded bore that receives a threaded control end of the valve member whereby, upon rotation of said valve support member, said valve member transitions linearly toward and away from the corresponding fluid flow passage.

5. The valve manifold of claim 4 wherein the valving end of the valve member comprises a non-circular paddle that maintains the valve member non-rotational.

6. The valve manifold of claim 1 wherein said sealing member comprises an annular seal having a diameter that is greater than the diameter of the fluid flow passage.

7. The valve manifold of claim 6 including a pair of annular seals on opposite sides of said valve member valving end.

8. The valve manifold of claim 1 wherein said valve member valving end is in the form of a paddle having opposed flat surfaces and said resilient seal member comprises a pair of O-rings supported at said respective flat surfaces.

9. The valve manifold of claim 1 wherein said valve member valving end is in the form of a paddle having opposed flat surfaces and said resilient seal member comprises a pair of O-rings supported by said body for contact with said respective flat surfaces.

10. The valve manifold of claim 1 wherein said valve member valving end is in the form of a paddle that extends across said fluid flow passage in opposed channels.

11. The valve manifold of claim 10 wherein the free end of the paddle extends into a closed channel.

12. A gate valve comprising:
a body;
at least one flow passage in said body through which a fluid is adapted to flow;
at least one valve member for controlling the fluid flow through said at least one passage and having closed and at least partially open positions;
said valve member having one end that is adapted to control the position of the valve member for transition transverse to said flow passage between open and closed positions;
said valve member having another end forming a valve gate that is adapted to extend through a valve passage that is transverse to and extends to opposite sides of said flow passage;
and a resilient seal member disposed between said valve gate and body and that, in the closed position of the valve member, provides a seal entirely about said flow passage between said valve gate and body so as to block flow through said flow passage, and that, in the at least partially open position of the valve member, enables fluid flow through said flow passage.

13. The gate valve of claim 12 including a valve support member disposed between a control handle and the valve member and rotatable by said handle to linearly move said valve member between open and closed positions thereof.

14. The gate valve of claim 12 wherein said resilient seal member comprises an annular seal having a diameter that is greater than the diameter of the fluid flow passage.

15. The gate valve of claim 12 wherein said valve gate is in the form of a paddle having opposed flat surfaces and said resilient seal member comprises a pair of O-rings supported at said respective flat surfaces.

16. The gate valve of claim 12 wherein said valve gate is in the form of a paddle that extends across said fluid flow passage in opposed channels.

17. A flow control valve comprising:
a valve body;
a flow passage in said valve body through which a fluid is adapted to flow;
a valve means for controlling the fluid flow through said flow passage and having a closed position and an at least partially open position;
control means for controlling said valve means;
a valve passage that is disposed substantially transverse to said flow passage and that accommodates a paddle means of said valve means;
and a resilient seal means disposed between said paddle means and valve body and that, in the closed position of the valve means, provides a seal entirely about said flow passage between said paddle means and body so as to block flow through said flow passage, and that, in the at least partially open position of the valve means, enables fluid flow through said flow passage.

18. The flow control valve of claim 17 including a valve support means disposed between a control handle and the valve means and rotatable by said handle to linearly move said valve means between open and closed positions thereof.

19. The flow control valve of claim 17 wherein said resilient seal means comprises an annular seal having a diameter that is greater than the diameter of the fluid flow passage.

20. The flow control valve of claim 17 wherein said paddle means have opposed flat surfaces and said resilient seal means comprises a pair of O-rings supported at said respective flat surfaces.
